(19) United States
(12) Patent Application Publication
(10) Pub. No.: US 2023/0053903 A1
(43) Pub. Date: Feb. 23, 2023

(54) METHOD, SYSTEM AND NON-TRANSITORY COMPUTER-READABLE RECORDING MEDIUM FOR SUPPORTING SEARCH OF CONTENTS

(71) Applicant: B4Play, Inc., Seoul (KR)

(72) Inventor: Young Min LEE, Seoul (KR)

(73) Assignee: B4Play, Inc., Seoul (KR)

(21) Appl. No.: 17/536,366

(22) Filed: Nov. 29, 2021

(30) Foreign Application Priority Data
Aug. 18, 2021 (KR) 10-2021-0108864

(51) Int. Cl. G06F 16/9532; G06F 40/30

(52) U.S. Cl. CPC G06F 16/9532; G06F 40/30

(57) ABSTRACT

A method for supporting search of contents is provided. The method includes the steps of: receiving a plurality of semantically connected query elements corresponding to different narrative elements from a user with respect to a target content; generating a search query on the basis of the plurality of query elements; and specifying, with reference to the search query and narrative data sets for the contents, the target content that matches with the search query among the contents.

### CROSS REFERENCE TO RELATED APPLICATION

This application claims priority to Korean Patent Application No. 10-2021-0108864 filed on Aug. 18, 2021, the entire contents of which are herein incorporated by reference.

### FIELD OF THE INVENTION

The present invention relates to a method, system, and non-transitory computer-readable recording medium for supporting search of contents.

### BACKGROUND

In recent years, various techniques have been introduced to support efficient search or recommendation of a content desired by a user.

As an example of related conventional techniques, Korean Laid-Open Patent Publication No. 10-2013-0009360 discloses the steps of: displaying a first menu for allowing selection of movies watched by a user; displaying a second menu for allowing user preference setting for each of the movies selected through the first menu; displaying a third menu for allowing selection of a movie genre preferred by the user; searching for a movie to be recommended on the basis of user information including information collected through at least one of the first to third menus; and displaying information related to the searched movie.

The conventional techniques usually search for or recommend a specific content with reference to a tag assigned to each content. According to the techniques introduced so far as well as the above conventional techniques, there is a problem that it is difficult to accurately search for or recommend a content desired by a user because the tag assigned to each content is in the format of a word or a simple combination of words. For example, when a tag “Rogue” is assigned to a specific game content, it is difficult to accurately search for or recommend the content desired by the user even if the user tries a search using the tag “Rogue”, because it is impossible to distinguish whether the game content is related to a game in which the user plays as a rogue or the user arrests a rogue, only with the tag “Rogue”.

In this connection, the inventor(s) present a technique for increasing the accuracy of a content search result by constituting data sets (e.g., tags) for contents as narrative data sets, and assisting a user to search for a content on the basis of the narrative data sets.

### SUMMARY OF THE INVENTION

One object of the present invention is to solve all the above-described problems in the prior art.

Another object of the invention is to: receive a plurality of semantically connected query elements corresponding to different narrative elements from a user with respect to a target content; generate a search query on the basis of the plurality of query elements; and specify, with reference to the search query and narrative data sets for contents, the target content that matches with the search query among the contents.

Yet another obj ect of the invention is to increase the accuracy of a content search result by constituting data sets (e.g., tags) for contents as narrative data sets, and assisting a user to search for a content on the basis of the narrative data sets.

The representative configurations of the invention to achieve the above objects are described below.

According to one aspect of the invention, there is provided a method for supporting search of contents, the method comprising the steps of: receiving a plurality of semantically connected query elements corresponding to different narrative elements from a user with respect to a target content; generating a search query on the basis of the plurality of query elements; and specifying, with reference to the search query and narrative data sets for the contents, the target content that matches with the search query among the contents.

According to another aspect of the invention, there is provided a system for supporting search of contents, the system comprising: a query element reception unit configured to receive a plurality of semantically connected query elements corresponding to different narrative elements from a user with respect to a target content; a search query generation unit configured to generate a search query on the basis of the plurality of query elements; and a content management unit configured to specify, with reference to the search query and narrative data sets for the contents, the target content that matches with the search query among the contents.

In addition, there are further provided other methods and systems to implement the invention, as well as non-transitory computer-readable recording media having stored thereon computer programs for executing the methods.

According to the invention, it is possible to: receive a plurality of semantically connected query elements corresponding to different narrative elements from a user with respect to a target content; generate a search query on the basis of the plurality of query elements; and specify, with reference to the search query and narrative data sets for contents, the target content that matches with the search query among the contents.

According to the invention, it is possible to increase the accuracy of a content search result by constituting data sets (e.g., tags) for contents as narrative data sets, and assisting a user to search for a content on the basis of the narrative data sets.

### BRIEF DESCRIPTION OF THE DRAWINGS

FIG. 1 schematically shows the configuration of an entire system for supporting search of contents according to one embodiment of the invention.

FIG. 2 specifically shows the internal configuration of a content search support system according to one embodiment of the invention.

FIG. 3 illustratively shows how to specify a target content according to one embodiment of the invention.

FIG. 4 illustratively shows how to specify a target content according to one embodiment of the invention.

FIG. 5 illustratively shows how to generate a narrative data set for a content according to one embodiment of the invention.

### DETAILED DESCRIPTION OF THE INVENTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures, and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the invention will be described in detail with reference to the accompanying drawings to enable those skilled in the art to easily implement the invention.

Herein, the term “content” or “contents” encompasses digital information or individual information elements comprised of text, symbol, speech, sound, image, video, and the like, which are accessible via communication networks. For example, such contents may comprise data such as text, image, video, audio, and links (e.g., web links) or a combination of at least two types of such data.

Meanwhile, although the embodiments related to a content search support service are described herein mainly focusing on the search of game contents, the contents to be searched for according to the invention are not limited to the game contents, and should be understood in the broadest sense as encompassing contents like movies, music, and the like.

Configuration of the Entire System

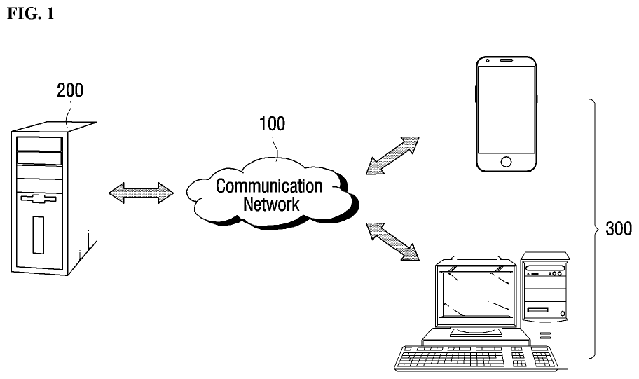

FIG. 1 schematically shows the configuration of the entire system for supporting search of contents according to one embodiment of the invention.

As shown in FIG. 1, the entire system according to one embodiment of the invention may comprise a communication network 100, a content search support system 200, and a device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

For example, the communication network 100 may be a wireless data communication network, at least a part of which may be implemented with a conventional communication scheme such as WiFi communication, WiFi-Direct communication, Long Term Evolution (LTE) communication, 5G communication, Bluetooth communication (including Bluetooth Low Energy (BLE) communication), infrared communication, and ultrasonic communication. As another example, the communication network 100 may be an optical communication network, at least a part of which may be implemented with a conventional communication scheme such as LiFi (Light Fidelity).

Next, the content search support system 200 according to one embodiment of the invention may function to: receive a plurality of semantically connected query elements corresponding to different narrative elements from a user with respect to a target content; generate a search query on the basis of the plurality of query elements; and specify, with reference to the search query and narrative data sets for contents, the target content that matches with the search query among the contents.

The configuration and functions of the content search support system 200 according to the invention will be discussed in more detail below.

Next, the device 300 according to one embodiment of the invention is digital equipment capable of connecting to and then communicating with the content search support system 200, and any type of digital equipment having a memory means and a microprocessor for computing capabilities, such as smart phones, tablets, smart watches, smart bands, smart glasses, desktop computers, notebook computers, workstations, personal digital assistants (PDAs), web pads, and mobile phones, may be adopted as the device 300 according to the invention.

In particular, the device 300 may include an application (not shown) for assisting a user to receive a service such as content search from the content search support system 200. The application may be downloaded from the content search support system 200 or an external application distribution server (not shown). Meanwhile, the characteristics of the application may be generally similar to those of a query element reception unit 210, a search query generation unit 220, a content management unit 230, a communication unit 240, and a control unit 250 of the content search support system 200 to be described below. Here, at least a part of the application may be replaced with a hardware device or a firmware device that may perform a substantially equal or equivalent function, as necessary.

Configuration of the Content Search Support System

Hereinafter, the internal configuration of the content search support system 200 200 crucial for implementing the invention and the functions of the respective components thereof will be discussed.

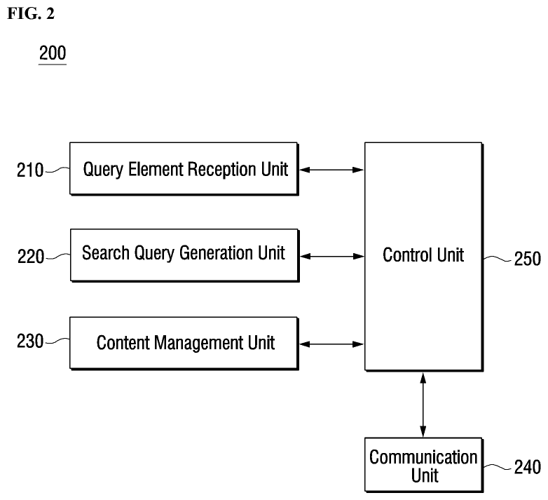

FIG. 2 specifically shows the internal configuration of the content search support system 200 according to one embodiment of the invention.

As shown in FIG. 2, the content search support system 200 according to one embodiment of the invention may comprise a query element reception unit 210, a search query generation unit 220, a content management unit 230, a communication unit 240, and a control unit 250. According to one embodiment of the invention, at least some of the query element reception unit 210, the search query generation unit 220, the content management unit 230, the communication unit 240, and the control unit 250 may be program modules to communicate with an external system (not shown). The program modules may be included in the content search support system 200 in the form of operating systems, application program modules, and other program modules, while they may be physically stored in a variety of commonly known storage devices. Further, the program modules may also be stored in a remote storage device that may communicate with the content search support system 200. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the content search support system 200 has been described as above, and it will be apparent to those skilled in the art that at least a part of the components or functions of the content search support system 200 may be implemented in the device 300 or a server (not shown) or included in an external system (not shown), as necessary.

First, the query element reception unit 210 according to one embodiment of the invention may function to receive a plurality of semantically connected query elements corresponding to different narrative elements from a user with respect to a target content.

Specifically, the query element reception unit 210 according to one embodiment of the invention may receive a plurality of query elements from a user, with respect to a content to be searched for by the user or to be recommended to the user (i.e., a target content). According to one embodiment of the invention, the target content may be specified with reference to a search query, and the plurality of query elements may refer to a plurality of elements constituting the search query. Further, according to one embodiment of the invention, the plurality of query elements may be semantically connected and correspond to different narrative elements. Here, according to one embodiment of the invention, a narrative element may refer to a kind of attribute that may be possessed by or correspond to each query element and each piece of data included in narrative data sets for contents to be described below.

According to one embodiment of the invention, the narrative element may be related to the five Ws and one H, a sentence element such as a subject, object, and predicate, or a status or meaning within a content (e.g., a protagonist, background, or the like in the case of a game content). Further, according to one embodiment of the invention, the narrative element may be related to a situation of a user who intends to use the content, or substance of the target content. However, the narrative element according to one embodiment of the invention is not limited to the above description, and may be diversely changed as long as the objects of the invention may be achieved.

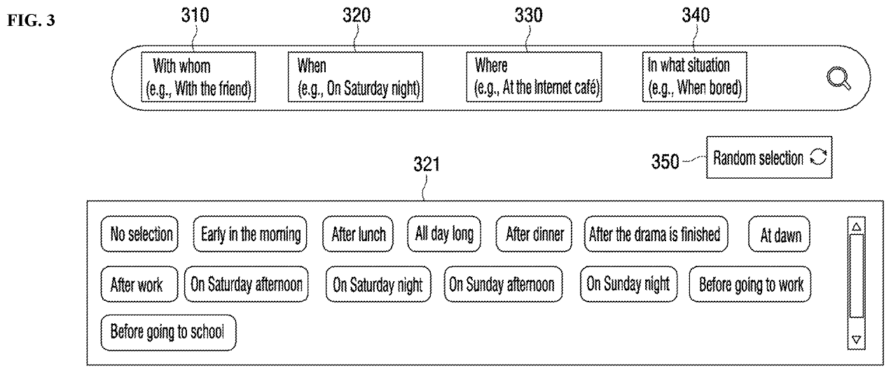

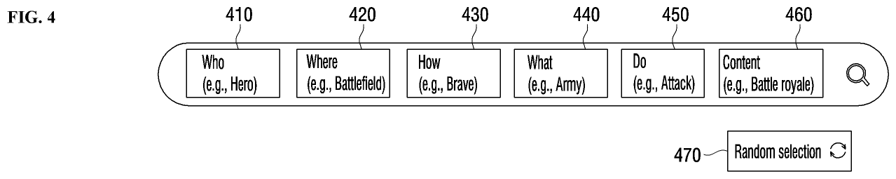

FIGS. 3 and 4 illustratively show how to specify a target content according to one embodiment of the invention.

For example, referring to FIG. 3, it may be assumed that a content according to one embodiment of the invention (the content may include a target content, which also applies hereinbefore and hereinafter) is related to a game content, and query elements according to one embodiment of the invention are related to a situation of a user who intends to use the target content. In this case, according to one embodiment of the invention, a plurality of query elements inputted from the user may correspond to different narrative elements “With whom” 310, “When” 320, “Where” 330, and “In what situation” 340, respectively. Further, the query element reception unit 210 according to one embodiment of the invention may receive, for example, “With the friend” 310, “On Saturday night” 320, “In an Internet café” 330, and “When bored” 340 as the plurality of query elements respectively corresponding to the above narrative elements.

Referring further to FIG. 3, according to one embodiment of the invention, the query element corresponding to the narrative element “With whom” 310 may include “Alone”, “Mom”, “Dad”, “Family”, “Younger brother”, “Older brother”, “Younger sister”, “Older sister”, “Friend”, “Boyfriend”, “Girlfriend”, “Husband”, “Wife”, “Son”, “Daughter”, and the like, in the above case. Further, according to one embodiment of the invention, the query element corresponding to the narrative element “When” 320 may include “Early in the morning”, “After lunch”, “All day long”, “After dinner”, “After the drama is finished”, “At dawn”, “After work”, “On Saturday afternoon”, “On Saturday night”, “Before going to work”, “Before going to school”, and the like. Furthermore, according to one embodiment of the invention, the query element corresponding to the narrative element “Where” 330 may include “In the living room”, “In the room”, “In the bed-sitting room”, “In the car”, “In the airplane”, “At the hotel”, “At the internet café”, “At the room café”, “At the relative's house”, “On the street”, “On the subway”, “At work”, “At the beauty shop”, “At the café”, and the like. In addition, according to one embodiment of the invention, the query element corresponding to the narrative element “In what situation” 340 may include “When to sleep early”, “When feeling troublesome to wash”, “When not to sleep”, “While drinking”, “When feeling like not going out”, “When feeling like running”, “When feeling like watching a horror movie”, “When depressed”, “When feeling like going to Europe”, “When on vacation”, “When it rains a lot”, “When feeling like enhancing interest in history”, and the like. However, the query elements related to the situation of the user who intends to use the target content according to one embodiment of the invention are not limited to the foregoing and may be diversely changed as long as the objects of the invention may be achieved.

As another example, referring to FIG. 4, it may be assumed that a content according to one embodiment of the invention is related to a game content, and query elements according to the embodiment of the present invention are related to substance of a target content. In this case, according to one embodiment of the present invention, a plurality of query elements inputted from the user may correspond to different narrative elements “Who” 410, “Where” 420, “How” 430, “What” 440, “Do” 450, and “Content” 460, respectively. Further, the query element reception unit 210 according to one embodiment of the invention may receive, for example, “Hero” 410, “Battlefield” 420, “Brave” 430, “Army” 440,

“Attack” 450, and “Battle royale” 460 as the plurality of query elements.

Referring further to FIG. 4, according to one embodiment of the invention, the query element corresponding to the narrative element “Who” 410 may include “Alien”, “Robot”, “Angel”, “Animal”, “Archer”, “Army”, “Astronaut”, “Baby”, “Rogue”, “Novice”, “Cook”, “CIA”, “Assassin”, and the like, in the above case. Further, according to one embodiment of the invention, the query element corresponding to the narrative element “Where” 420 may include “World War I”, “1990s”, “Africa”, “Airport”, “Abandoned”, “Another world”, “Apocalypse”, “Autumn”, “Avalanche”, “Beach”, “NBA”, “School”, and the like.

Furthermore, according to one embodiment of the invention, the query element corresponding to the narrative element “How” 430 may include “Absurd”, “Beautiful”, “Brutal”, “Elaborately”, “Story branching”, “Fast-paced”, “Animation”, “Pixel graphics”, and the like. In addition, according to one embodiment of the invention, the query element corresponding to the narrative element “What” 440 may include “Revenge for the son”, “Cycling”, “Necromancy”, “Accelerometer”, “Baseball”, “Building”, “Animal”, “Coloring”, “Corruption”, and the like. Moreover, according to one embodiment of the invention, the query element corresponding to the narrative element “Do” 450 may include “Make the Brotherhood”, “Goal”, “Air combat”, “Audio production”, “Growth”, “Plunder”, “Raid”, and the like. Also, according to one embodiment of the invention, the query element corresponding to the narrative element “Content” 460 may include “Sports”, “Racing”, “4X”, “Automatic battle”, “Inference”, “Drinking party game”, “Simulation”, “Zelda-like”, “Room escape”, “Open world adventure”, and the like. Besides, according to one embodiment of the invention, the above narrative elements may further include narrative elements such as “When” (e.g., Antiquity, the 1st century BC) and “Characteristics” (e.g., Rich historical story). However, the query elements related to the substance of the target content according to one embodiment of the invention are not limited to the foregoing and may be diversely changed as long as the objects of the invention may be achieved.

Meanwhile, in order to allow the user to input the plurality of query elements, the query element reception unit 210 according to one embodiment of the invention may provide the user with information on each of the query elements. For example, referring to FIG. 3, when the user intends to input a query element corresponding to the narrative element “When” 320, the query element reception unit 210 according to one embodiment of the invention may provide the user with examples of a keyword that may be inputted as the query element (321).

Meanwhile, the query element reception unit 210 according to one embodiment of the invention may determine a narrative element corresponding to each query element according to a position where the query element is inputted from the user.

For example, referring to FIG. 4, when the content is related to a game content and a query element “Rogue” is inputted from the user into a position of the item “Who” 410, the query element reception unit 210 according to one embodiment of the invention may determine that a narrative element corresponding to “Rogue” is related to “Who”. As another example, when a query element “Rogue” is inputted from the user into a position of the item “What” 440, the query element reception unit 210 according to one embodiment of the invention may determine that a narrative element corresponding to “Rogue” is related to “What”. Through the foregoing, the query element reception unit 210 according to one embodiment of the invention may distinguish whether the game content desired by the user is related to a game in which the user plays as a rogue or the user arrests a rogue. The content search support system 200 according to one embodiment of the invention may accurately search for or recommend the content desired by the user on the basis of the foregoing.

Meanwhile, the query element reception unit 210 according to one embodiment of the invention may randomly input a plurality of semantically connected query elements corresponding to different narrative elements with respect to the target content, according to the user's selection.

For example, referring to FIGS. 3 and 4, when the user selects “Random selection” 350 and 470, the query element reception unit 210 according to one embodiment of the invention may randomly input a plurality of semantically connected query elements corresponding to different narrative elements, so that a content having a unique style may be specified as the target content.

Next, when the plurality of semantically connected query elements corresponding to the different narrative elements are received from the user with respect to the target content, the search query generation unit 220 according to one embodiment of the invention may function to generate a search query on the basis of the plurality of query elements.

Specifically, on the basis of the plurality of query elements received as above, the search query generation unit 220 according to one embodiment of the invention may generate a search query that is constituted in a state in which the plurality of query elements are semantically connected. For example, the search query generation unit 220 according to one embodiment of the invention may generate the search query as a sentence with reference to the narrative elements respectively corresponding to the plurality of query elements. Through the foregoing, the target content searched for by the user inputting the plurality of query elements may be a content that meets the user's intention.

Next, with reference to the search query generated by the search query generation unit 220 according to one embodiment of the invention and narrative data sets for contents, the content management unit 230 according to one embodiment of the invention may function to specify the target content that matches with the search query among the contents.

Specifically, according to one embodiment of the invention, contents to be searched by the user may be contained in a content management server (not shown), and each of the contents may be associated with a narrative data set for the content.

More specifically, according to one embodiment of the invention, a narrative data set for a content may refer to a set of data that may be assigned to the content in the format of tags or the like. According to one embodiment of the invention, at least one narrative element may correspond to each piece of data included in the set of data as described above, so that each piece of the data may be semantically connected with one another. Further, the content management unit 230 according to one embodiment of the invention may compare the search query with the narrative data sets for the contents to specify the target content that matches with the search query among the contents.

Meanwhile, on the basis of context information of keywords included in a user review on a content, the content management unit 230 according to one embodiment of the invention may generate a narrative data set for the content. According to one embodiment of the invention, the user review on the content may include, but is not limited to, a user's post (e.g., blog post), article, and the like posted on the web with respect to the content.

Specifically, the content management unit 230 according to one embodiment of the invention may extract a keyword from the user review on the content, and derive a narrative element corresponding to the keyword on the basis of context information of the keyword. Further, when the keyword and the corresponding narrative element are not included in the narrative data set for the content, the content management unit 230 according to one embodiment of the invention may appropriately incorporate the keyword and the corresponding narrative element into the narrative data set for the content, so that the narrative data set for the content may be augmented. Furthermore, the content management unit 230 according to one embodiment of the invention may provide the user with the augmented narrative data set for the content as information on each query element as described above. Meanwhile, when the keyword and the corresponding narrative element are already included in the narrative data set for the content, the content management unit 230 according to one embodiment of the invention may increase a score, rating, or the like of the keyword and the corresponding narrative element, so that the keyword and the corresponding narrative element may be treated with higher importance in the narrative data set.

Further, the content management unit 230 according to one embodiment of the invention may derive the keywords and the corresponding narrative elements as above using various known natural language processing algorithms.

More specifically, in order to generate a narrative data set for a content on the basis of context information of a keyword included in a user review on the content, the content management unit 230 according to one embodiment of the invention may acquire data for estimating the context information of the keyword from the user review. Further, the content management unit 230 according to one embodiment of the invention may analyze the acquired data using a machine learning-based context information estimation model, and derive a narrative element corresponding to the keyword on the basis of the context information of the keyword which is estimated on the basis of a result of the analysis. Furthermore, the content management unit 230 according to one embodiment of the invention may refer to the derived narrative element of the keyword in deriving a narrative element corresponding to another keyword using the above context information estimation model.

Meanwhile, according to one embodiment of the invention, the context information estimation model may be implemented on the basis of algorithms such as, but not limited to, a convolutional neural network (CNN), long short-term memory (LSTM), and a combination of the foregoing (CNN-LSTM).

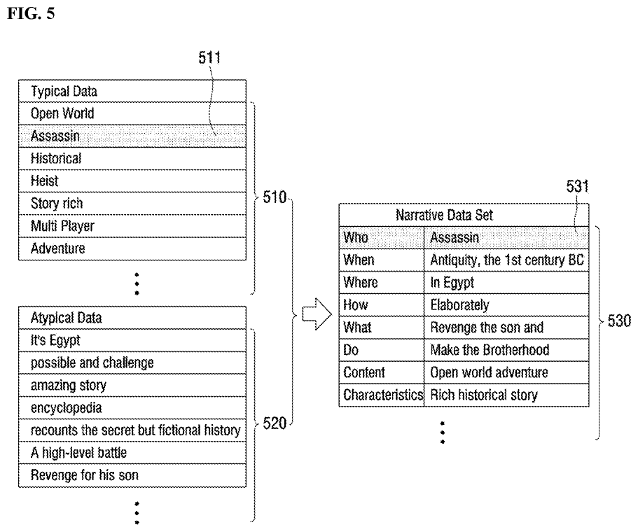

FIG. 5 illustratively shows how to generate a narrative data set for a content according to one embodiment of the invention.

Referring to FIG. 5, it may be assumed that a content according to one embodiment of the invention is a game content, for example. In this case, the content management unit 230 according to one embodiment of the invention may acquire at least one of typical data 510 and atypical data 520 as data for estimating context information of a keyword from a user review. Further, the content management unit 230 according to one embodiment of the invention may analyze at least one of the typical data 510 and the atypical data 520 acquired as above by the morpheme, using a machine learning-based context information estimation model. For example, the content management unit 230 according to one embodiment of the invention may extract “Assassin” 511 as a keyword from a specific user review according to the analysis, and determine a type of the extracted keyword 511 (e.g., a character, time, or place).

Further, when the type of the extracted keyword 511 is a character, for example, weight of the keyword 511 may be determined on the basis of a frequency of occurrence or the like of the keyword in the user review. When the weight of the keyword 511 is determined to be great, the content management unit 230 according to one embodiment of the invention may determine whether the keyword 511 indicates a protagonist or a villain who opposes the protagonist, on the basis of the user review or the like. Furthermore, the content management unit 230 according to one embodiment of the invention may determine a contextual relationship between the keyword 511 and other data (which may include other keywords) included in the typical data 510 and/or the atypical data 520.

Further, for example, the content management unit 230 according to one embodiment of the invention may derive that the keyword 511 indicates a protagonist on the basis of the above analysis and determination, and may accordingly derive a narrative element corresponding to the keyword 511 as “Who” 531. Furthermore, the content management unit 230 according to one embodiment of the invention may generate a narrative data set 530 for the content with reference to the narrative element corresponding to the specific keyword 511 derived as above. In this case, since the keyword “Assassin” 511 corresponds to the narrative element “Who” 531 (i.e., since the protagonist is an assassin), the narrative data set 530 for the content may be generated with reference to related words or keywords such as “Elaborate”, “Assassination”, and “Revenge”.

As another example, according to one embodiment of the present invention, it may be assumed that the content according to one embodiment of the invention is a game content, and a user review on the game content is written saying “I watched the ending after 40 hours since I started this game. After watching the ending scene, I understood why the protagonist had to break codes, earn money, and train to shoot. 40 hours is really worth investing. If you play the game only 2 hours a day after work, you can finish it in a month. The 2 hours may let you forget all things and focus.” In this case, the content management unit 230 according to one embodiment of the invention may derive “A game to focus on for a short time”, “An ecstasy of the ending”, and the like as keywords from the user review, using a machine learning-based context information estimation model.

Meanwhile, the content management unit 230 according to one embodiment of the invention may acquire user feedback on the narrative data set for the content, and reflect the user feedback in the narrative data set for the content.

For example, the content management unit 230 according to one embodiment of the invention may provide the user with the narrative data set for the content generated using a machine learning-based context information estimation model. In this case, the content management unit 230 according to one embodiment of the invention may provide a plurality of keywords for each narrative element included in the narrative data set for the content. In response, the user may vote for a keyword that is most appropriate to the content for each narrative element. Further, the content management unit 230 according to one embodiment of the invention may reflect a result of the vote in the narrative data set for the content, and allow the result of the vote to be used as training data of the context information estimation model.

Next, the communication unit 240 according to one embodiment of the invention may function to enable data transmission/reception from/to the query element reception unit 210, the search query generation unit 220, and the content management unit 230.

Lastly, the control unit 250 according to one embodiment of the invention may function to control data flow among the query element reception unit 210, the search query generation unit 220, the content management unit 230, and the communication unit 240. That is, the control unit 250 according to one embodiment of the invention may control data flow into/out of the content search support system 200 or data flow among the respective components of the content search support system 200, such that the query element reception unit 210, the search query generation unit 220, the content management unit 230, and the communication unit 240 may carry out their particular functions, respectively.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks, and magnetic tapes; optical media such as compact disk-read only memory (CD-ROM) and digital versatile disks (DVDs); magneto-optical media such as floptical disks; and hardware devices such as read-only memory (ROM), random access memory (RAM), and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for supporting search of contents, the method comprising the steps of:
receiving a plurality of semantically connected query elements corresponding to different narrative elements from a user with respect to a target content;
generating a search query on the basis of the plurality of query elements; and
specifying, with reference to the search query and narrative data sets for the contents, the target content that matches with the search query among the contents.

2. The method of claim 1, wherein the narrative data sets for the contents are generated on the basis of context information of keywords included in user reviews on the contents.

3. The method of claim 1, wherein the plurality of query elements are associated with a situation of the user who intends to use the target content.

4. The method of claim 1, wherein the plurality of query elements are associated with substance of the target content.

5. The method of claim 1, wherein in the receiving step, the plurality of query elements are randomly inputted according to the user's selection.

6. The method of claim 1, wherein in the generating step, the search query is generated as a sentence.

7. The method of claim 1, wherein the contents and the target content are related to game contents.

8. The method of claim 2, wherein the narrative data sets for the contents are generated by analyzing data for estimating the context information of the keywords acquired from the user reviews, using a machine learning-based context information estimation model, and deriving narrative elements corresponding to the keywords on the basis of the context information of the keywords which is estimated on the basis of a result of the analysis.

9. The method of claim 8, wherein user feedback acquired with respect to the narrative data sets for the contents, which are generated using the context information estimation model, is reflected in the narrative data sets for the contents.

10. A non-transitory computer-readable recording medium having stored thereon a computer program for executing the method of claim 1.

11. A system for supporting search of contents, the system comprising:
a query element reception unit configured to receive a plurality of semantically connected query elements corresponding to different narrative elements from a user with respect to a target content;
a search query generation unit configured to generate a search query on the basis of the plurality of query elements; and
a content management unit configured to specify, with reference to the search query and narrative data sets for the contents, the target content that matches with the search query among the contents.

12. The system of claim 11, wherein the content management unit is configured generate the narrative data sets for the contents on the basis of context information of keywords included in user reviews on the contents.

13. The system of claim 11, wherein the plurality of query elements are associated with a situation of the user who intends to use the target content.

14. The system of claim 11, wherein the plurality of query elements are associated with substance of the target content.

15. The system of claim 11, wherein the query element reception unit is configured to randomly input the plurality of query elements according to the user's selection.

16. The system of claim 11, wherein the search query generation unit is configured to generate the search query as a sentence.

17. The system of claim 11, wherein the contents and the target content are related to game contents.

18. The system of claim 12, wherein the content management unit is configured to generate the narrative data sets for the contents by analyzing data for estimating the context information of the keywords acquired from the user reviews, using a machine learning-based context information estimation model, and deriving narrative elements corresponding to the keywords on the basis of the context information of the keywords which is estimated on the basis of a result of the analysis.

19. The system of claim 18, wherein the content management unit is configured to reflect user feedback acquired with respect to the narrative data sets for the contents, which are generated using the context information estimation model, in the narrative data sets for the contents.
